(19) United States
(12) Patent Application Publication
(10) Pub. No.: US 2020/0131324 A1
(43) Pub. Date: Apr. 30, 2020

(54) THERMOSETTING RESIN COMPOSITION FOR FIBER-REINFORCED COMPOSITE MATERIAL, PREFORM, FIBER-REINFORCED COMPOSITE MATERIAL, AND METHOD OF PRODUCING FIBER-REINFORCED COMPOSITE MATERIAL

(71) Applicant: Toray Industries, Inc., Tokyo (JP)

(72) Inventors: Masanori Hirano, Nagoya (JP); Nobuyuki Tomioka, Nagoya (JP)

(21) Appl. No.: 16/623,924

(22) PCT Filed: Sep. 20, 2018
(86) PCT No.: PCT/JP2018/034754

§ 371 Date: Dec. 18, 2019

(30) Foreign Application Priority Data
Sep. 28, 2017 (JP) 2017-188113

(51) Int. Cl. C08J 5/24; C08J 5/04; C08L 63/04; C08K 5/09; C08K 5/3445; C08K 5/00; C08K 5/5313; C08K 7/06; C08K 7/14

(52) U.S. Cl. CPC C08J 5/24; C08J 5/04; C08L 63/04; C08K 5/09; C08K 5/3445; C08L 2312/00; C08K 5/5313; C08K 7/06; C08K 7/14; C08L 2203/30; C08K 5/0025

(57) ABSTRACT

A thermosetting resin composition for a fiber-reinforced composite material includes a domain of a base resin [A]; and a domain of a curing agent [B] and/or a domain of a catalyst [C], the thermosetting resin composition having a specific gravity of 0.90 to 1.30, and a complex viscosity η* determined by dynamic viscoelasticity measurement at 25° C. of 1×10⁷ Pa·s or more.

### TECHNICAL FIELD

This disclosure relates to a thermosetting resin composition used for a fiber-reinforced composite material, a preform and a fiber-reinforced composite material produced from the preform, and a method of producing a fiber-reinforced composite material.

### BACKGROUND

A fiber-reinforced composite material containing a reinforcing fiber and a matrix resin can be designed using advantages of the reinforcing fiber and the matrix resin so that the fiber-reinforced composite material has been more widely used in the fields of aerospace, sports, general industry and the like.

As the reinforcing fiber, fibers such as glass fibers, aramid fibers, carbon fibers, and boron fibers are used. As the matrix resin, both thermosetting resins and thermoplastic resins are used. The thermosetting resins easily impregnated into the reinforcing fibers are more often used. As the thermosetting resin, resins such as epoxy resins, unsaturated polyester resins, vinyl ester resins, phenol resins, bismaleimide resins, and cyanate resins are used.

In general, to produce a fiber-reinforced composite material, methods such as a prepreg method, hand lay-up, filament winding, pultrusion, resin transfer molding (RTM), film bag molding, and press molding are employed. Particularly when productivity is required, the RTM method, film bag molding, and press molding that have good productivity are preferably employed.

In particular, the demand for fiber-reinforced composite materials such as carbon fiber-reinforced composite materials is recently increasing especially for uses in aircraft and cars. To employ the fiber-reinforced composite materials for these uses more generally, materials that have a low cost and low environmental load have been desired.

A matrix resin used in the above-mentioned conventional methods of producing a fiber-reinforced composite material is liquid or semisolid at normal temperature so that the matrix resin has a sufficient impregnating ability into a reinforcing fiber substrate. Such a resin tends to remain in a resin-blending device and a resin-injecting device during the use, and make a great loss. For example, when a prepreg method is employed, a process is performed in which a resin film is produced from a matrix resin and the resin is then impregnated into a reinforcing fiber. When the resin film is produced, a subsidiary material such as a releasable film is often needed, and the cost easily increases. Moreover, because the resin composition needs to be liquid or semisolid at normal temperature, it is difficult to mix a large amount of component that is solid at normal temperature.

In addition, when the liquid or semisolid thermosetting resin is a one-component resin composition in which a base resin, a curing agent, and a catalyst component are compatibilized in advance, it is difficult to balance the high-speed curability and the storage stability in the resin. In a molding method such as RTM, a two-component resin composition is sometimes used. In the two-component resin composition, resins having good high-speed curability are obtained by preparing a base resin component and a curing agent-catalyst component separately and mixing them immediately before use, however, the work and equipment in the manufacturing site are complex.

In Japanese Examined Patent Application Publication No. 3-29098, a powdered epoxy resin composition is disclosed that is produced by pulverizing a crystalline epoxy resin that is solid at 30° C. and a solid curing agent, pressure-bonding them, and then pulverizing the resulting product again.

In Japanese Patent No. 5315057, a resin composition is disclosed that contains a crystalline epoxy resin for use in a fiber-reinforced composite material, a crystalline curing agent, and a curing accelerator.

The material described in Japanese Examined Patent Application Publication No. 3-29098 is a solid resin composition that hardly causes composition unevenness in the resin cured product. However, a balance between high-speed curability and storage stability is not described, and when a fiber-reinforced composite material is produced from the above-mentioned material, a surface pit and an internal void are caused so that the strength property is much deteriorated.

The material described in Japanese Patent No. 5315057 is a resin composition in which a crystalline epoxy resin, a crystalline curing agent, and a catalyst are compatibilized. The resin composition is, however, not good in a balance between high-speed curability and storage stability of the resin.

It could therefore be helpful to provide a thermosetting resin composition for a fiber-reinforced composite material that overcomes the defects of the conventional techniques and is good in a balance between high-speed curability and storage stability, the handling property at normal temperature, and the impregnating ability into a reinforcing fiber substrate, a preform for a fiber-reinforced composite material produced from the thermosetting resin composition, and a fiber-reinforced composite material.

### SUMMARY

We thus provide:

(1) A thermosetting resin composition for a fiber-reinforced composite material, the thermosetting resin composition containing:
a domain of a base resin [A]; and
a domain of a curing agent [B] and/or a domain of a catalyst [C],
the thermosetting resin composition having a specific gravity of 0.90 to 1.30, and a complex viscosity η* determined by dynamic viscoelasticity measurement at 25° C. of 1×10⁷ Pa·s or more.
(2) A thermosetting resin composition for a fiber-reinforced composite material, the thermosetting resin composition containing:
a domain of a base resin [A]; and
a domain of a curing agent [B] and/or a domain of a catalyst [C],
the thermosetting resin composition having a porosity of 0.1 to 25%, and a complex viscosity η* determined by dynamic viscoelasticity measurement at 25° C. of 1×10⁷ Pa·s or more.
(3) A preform for a fiber-reinforced composite material, the preform containing:
the thermosetting resin composition for a fiber-reinforced composite material according to the above (1) or (2); and
a dry reinforcing fiber substrate.
(4) A fiber-reinforced composite material that is a molded body containing a reinforcing fiber substrate and the thermosetting resin composition for a fiber-reinforced composite material according to the above (1) or (2) impregnated into the reinforcing fiber substrate, wherein the thermosetting resin composition is present as a cured product in the molded body.
(5) A method of producing a fiber-reinforced composite material, the method including:
a molding step of melting the thermosetting resin composition for a fiber-reinforced composite material according to the above (1) or (2), and molding the thermosetting resin composition while impregnating the thermosetting resin composition into a dry reinforcing fiber substrate; and
a curing step of curing the thermosetting resin composition that is impregnated into the dry reinforcing fiber substrate and molded.

Our thermosetting resin composition for a fiber-reinforced composite material is good in a balance between high-speed curability and storage stability, the handling property at normal temperature, and the impregnating ability into a reinforcing fiber substrate. Our preform for a fiber-reinforced composite material is produced from the thermosetting resin composition, and we provide a fiber-reinforced composite material.

### DETAILED DESCRIPTION

Hereinafter, desirable examples will be described.

The thermosetting resin composition for a fiber-reinforced composite material may be a thermosetting resin composition containing: a domain of a base resin [A]; and a domain of a curing agent [B] and/or a domain of a catalyst [C], the thermosetting resin composition having a specific gravity of 0.90 to 1.30, and a complex viscosity η* determined by dynamic viscoelasticity measurement at 25° C. of 1×10⁷ Pa·s or more. A “thermosetting resin composition for a fiber-reinforced composite material” is sometimes referred to as a “thermosetting resin composition”.

The thermosetting resin composition for a fiber-reinforced composite material may be a thermosetting resin composition containing: a domain of a base resin [A]; and a domain of a curing agent [B] and/or a domain of a catalyst [C], the thermosetting resin composition having a porosity of 0.1 to 25%, and a complex viscosity η* determined by dynamic viscoelasticity measurement at 25° C. of 1×10⁷ Pa·s or more.

The thermosetting resin composition has a complex viscosity η* determined by dynamic viscoelasticity measurement at normal temperature of 1×10⁷ Pa·s or more. “Normal temperature” means a temperature of 25° C. When the thermosetting resin composition has the above-mentioned complex viscosity η*, the thermosetting resin composition is solid at normal temperature. As a result, the thermosetting resin composition has a good handling property at normal temperature, and the cost of producing the fiber-reinforced composite material is easily reduced. The upper limit of the complex viscosity η* is not particularly limited, but generally about 1×10⁹ Pa·s.

In dynamic viscoelasticity measurement, ARES-G2 (manufactured by TA Instruments) is used. The complex viscosity η* can be measured using the measuring device by setting a sample on a 8 mm parallel plate, applying a pulling cycle of 0.5 Hz, and measuring the complex viscosity η* at a temperature of 0 to 300° C. at a temperature rising rate of 1.5° C./min.

The thermosetting resin composition contains various types of generally used thermosetting resins that can be employed as long as the desired effects are satisfied. As the thermosetting resin, for example, epoxy resins, phenol resins, unsaturated polyester resins, vinyl ester resins, bismaleimide resins, cyanate resins, benzoxazine resins, urethane resins, and urea resins can be suitably employed.

The base resin [A] used in the thermosetting resin composition is a component in which a curing reaction progresses by heating to form a cross-linked structure. The base resin [A] is preferably a monomer component. As the base resin [A], thermosetting components such as compounds having an epoxy group, compounds having a phenol group, compounds having a vinyl group, compounds having a bismaleimide structure, compounds having an isocyanate group, oxazine compounds, compounds having a hydroxyl group, and compounds having an amino group can be used.

Among the above-mentioned thermosetting resins, the thermosetting resin composition preferably contains an epoxy resin from the viewpoint of the adhesion property with a reinforcing fiber and the handling property. When the thermosetting resin composition contains an epoxy resin as a thermosetting resin, the base resin [A] contains a compound having one or more, preferably two or more epoxy groups in one molecule. The epoxy resin may contain only one compound having an epoxy group, or may be a mixture of a plurality of compounds.

The curing agent [B] is a component that forms a covalent bond to cure the thermosetting resin when compatibilized with the base resin. When the thermosetting resin is an epoxy resin, compounds having an active group that can react with an epoxy group can be used as a curing agent. For example, acid anhydrides and phenol compounds can be used.

The catalyst [C] is a component that makes a single curing reaction of the base resin, and/or a curing reaction by forming a bond between the base resin and the curing agent proceed rapidly and smoothly. When the thermosetting resin is an epoxy resin, imidazole derivatives and organophosphorus compounds can be used as a catalyst.

The thermosetting resin composition is a thermosetting resin composition having a domain of the base resin [A], and a domain of the curing agent [B] and/or a domain of the catalyst [C]. The phrase “having a domain of each component” means that the components in the resin composition are not uniformly compatibilized at a molecular level, but dispersed in a state where each component has a domain diameter of micrometer order. In general, each domain is formed to be in contact with a different domain at an interface. “Micrometer order” means 0.1 μm to 10000 μm.

The thermosetting resin composition having a domain of each component can be produced by, for example, mixing the powder raw materials of the components, and pressure-bonding the mixture with a press or the like as described below. The production method is not limited to the above-mentioned method. For example, the thermosetting resin composition having a domain of each component can be produced by heating and melting the components to be compatibilized with each other, and then cooling the resulting product to precipitate and solidify each component domain by domain.

The distribution form of the domain of each component can be determined using various types of two-dimensional mapping methods. In particular, mapping analyses using active energy rays such as ultraviolet rays, visible rays, infrared rays, electron rays, and X-rays are effective, and mapping analyses that can identify chemical compositions are more preferable.

In particular, the domain diameter of each component is determined by performing chemical composition mapping through infrared spectroscopy, measuring 100 domain widths in the range in which the absorbance of each component is equal to or higher than the threshold value, and calculating the average of the domain widths as the domain diameter. When it is difficult to determine the components only through infrared spectroscopy, the components may be determined by a combination of infrared spectroscopy and elemental analysis. Moreover, the domain diameter may be determined by measuring 100 domain widths that are widths of each component observed with a microscope using a dye, and calculating the average of the domain widths as the domain diameter.

When the components of the thermosetting resin composition are not uniformly compatibilized at a molecular level and the thermosetting resin composition has a domain of each component, the base resin, and the curing agent and/or the catalyst are in contact with each other at a low rate so that the thermosetting resin composition can have good storage stability. Moreover, when a thermosetting resin having good high-speed curability is employed, the thermosetting resin composition is good in a balance between high-speed curability and storage stability.

The domain diameter of each component in the thermosetting resin composition is preferably 0.5 to 500 μm, more preferably 1 to 300 μm, and still more preferably 10 to 200 μm. When the domain diameter of each component is 0.5 to 500 μm, sufficient storage stability is secured, and the cured product having little unevenness is easily obtained after the thermosetting resin is melted and cured.

A product of a curing time x (min) at 150° C. and a curing reaction progress rate y (%) after one week storage under an environment at 40° C. preferably satisfies Formula (1), and more preferably satisfies Formula (2) below.

0≤x×y≤40 (1))

0≤x×y≤15 (2)

In Formula (1) and Formula (2), x satisfies 0.1≤x≤300, and y satisfies 0≤y≤50.

The curing time x (min) at 150° C. is obtained by measuring an ion viscosity using the dielectric measuring device described below, calculating a cure index from the ion viscosity, and determining the time when the cure index value exceeds 90%. The curing reaction progress rate y (%) is determined by measuring a calorific value due to the curing reaction of the resin composition immediately after the preparation and a calorific value after one week storage under an environment at 40° C. using differential scanning calorimetry (DSC), and calculating the ratio between the calorific values using Formula (5) below.

x×y in Formula (1) and Formula (2) is an index that shows a balance between high-speed curability and storage stability of the thermosetting resin composition. In general, high-speed curability and storage stability of the thermosetting resin are in a trade-off relationship, however, the thermosetting resin composition can have a good balance between high-speed curability and storage stability as described above.

From the viewpoint of ensuring the above-mentioned high-speed curability and storage stability, the thermosetting resin composition preferably contains the catalyst [C], and preferably has a content of the catalyst [C] of 1 to 30% by mass, more preferably 1 to 20% by mass, and still more preferably 2 to 15% by mass based on 100% by mass of the thermosetting resin composition for a fiber-reinforced composite material. The thermosetting resin composition may have a content of the catalyst [C] in the range from any lower limit to any upper limit described above. When the thermosetting resin composition has a content of the catalyst [C] of 1 to 30% by mass, the thermosetting resin composition has good high-speed curability and easily maintains good storage stability.

The molar number ratio of active groups in the curing agent [B] to active groups in the base resin [A] is preferably 0.5 to 2.0, and more preferably 0.8 to 1.6. When the molar number ratio of active groups in the curing agent [B] to active groups in the base resin [A] is 0.5 to 2.0, the fiber-reinforced composite material easily has good mechanical characteristics and heat resistance.

The thermosetting resin composition may have a specific gravity of 0.90 to 1.30, preferably 0.95 to 1.25, and more preferably 1.00 to 1.20. The thermosetting resin composition may have a specific gravity in the range from any lower limit to any upper limit described above. When the thermosetting resin composition has a specific gravity of less than 0.90, many pores are present in the thermosetting resin composition, and the resin is fragile and poor in the handling property so that the fiber-reinforced composite material tends to be a molded body having many internal voids. On the other hand, when the thermosetting resin composition has a specific gravity of more than 1.30, the density of the thermosetting resin composition is too high and the thermosetting resin composition is sometimes hardly melted.

The thermosetting resin composition may have a porosity of 0.1 to 25%, preferably 0.1 to 20%, and more preferably 0.1 to 16%. The porosity is calculated from the values of the specific gravity of the thermosetting resin composition and the specific gravity of a thermosetting resin composition having substantially no pore using Formula (3) described below. The specific gravity of the thermosetting resin composition having substantially no pore is calculated by summing up the specific gravities of components contained in the thermosetting resin composition according to the volume fraction at the compounding ratio among the components.

Porosity (%)=100−(specific gravity of thermosetting resin composition)/(specific gravity of thermosetting resin composition having no pore)×100 (3)

When the thermosetting resin composition has a porosity of 0.1 to 25%, it has a sufficient handling property at normal temperature and good impregnating ability into a reinforcing fiber substrate.

The above-mentioned thermosetting resin composition can be produced by, for example, mixing powder raw materials of the components of the base resin [A], and the curing agent [B] and/or the catalyst [C] sufficiently, and then pressing the mixture to pressure-bond the components. The pressure in the pressing is preferably 5 to 100 MPa, and more preferably 10 to 50 MPa. The pressure range may be from any lower limit to any upper limit described above. When the pressure is 5 to 100 MPa, the components are easily subjected to sufficient pressure-bonding, and the resin composition easily has a better handling property.

The form of the thermosetting resin composition is not particularly limited. Thermosetting resin compositions having various forms such as clump, bar, plate, film, fiber, or granule forms can be used. In particular, from the viewpoint of the impregnating ability into a reinforcing fiber and the handling property, the clump, plate, and granule forms are preferable.

The thermosetting resin composition preferably has a longest diameter of 1.5 mm or more, more preferably 3 mm or more, and still more preferably 10 mm or more. With a longest diameter of less than 1.5 mm, the resin composition easily contains air when heated and melted, and impregnated into a fiber-reinforced substrate. As a result, the void amount in the molded body increases when the resin is cured, and the strength property is easily deteriorated. “Longest diameter” means the length of the longest part in the thermosetting resin composition. The upper limit of the longest diameter is not particularly limited, but generally about 1 m (1000 mm).

The thermosetting resin composition preferably has a total content of the crystalline component of 70% by mass or more and 100% by mass or less, more preferably 80% by mass or more and 100% by mass or less, and still more preferably 90% by mass or more and 100% by mass or less based on 100% by mass of the thermosetting resin composition. When the thermosetting resin composition contains a plurality of different crystalline components, “total content of the crystalline component” means the total amount of the crystalline components. When the thermosetting resin composition has a total content of the crystalline component of 70% by mass or more, the thermosetting resin composition easily has both handling property at room temperature and impregnating ability into a reinforcing fiber when heated to a high temperature.

“Crystalline component” means a component that has a melting point equal to or higher than normal temperature, and is solid at normal temperature. The melting point can be determined by differential scanning calorimetry (DSC) in accordance with JIS K 7121:2012 as described below.

Examples of the component that is solid at normal temperature include glassy solid components, however, the viscosity of the glassy solid components that are heated to a high temperature is hardly lowered so that the glassy solid components have a poor impregnating ability into a reinforcing fiber when heated to a high temperature. “Glassy solid component” means a component that does not have a melting point equal to or higher than normal temperature, but has a glass transition temperature. The glass transition temperature is determined by differential scanning calorimetry (DSC) in accordance with JIS K 7121:1987. A sample to be subjected to the measurement of the glass transition temperature is put in an aluminum crucible, and the measurement is performed in a nitrogen atmosphere at a temperature rising rate of 40° C./min. The temperature at the intermediate point of the displacement in the region where the baseline of the obtained DSC curve shifts to the endothermic side is employed as the glass transition temperature.

Moreover, it is preferable that the thermosetting resin composition contain a plurality of crystalline components at a content of 10% by mass or more based on 100% by mass of the thermosetting resin composition. The difference between the melting points of the crystalline component having the highest melting point and the crystalline component having the lowest melting point among the crystalline components is preferably 60° C. or lower, more preferably 50° C. or lower, and still more preferably 40° C. or lower. When the difference between the melting points of the crystalline components is 60° C. or lower, the components easily start to melt at the same time when the composition is heated and pressed, and the obtained cured product easily has a uniform composition.

The thermosetting resin composition may contain other components as long as the desired effect is not impaired.

The dry reinforcing fiber used may be various organic and inorganic fibers such as glass fibers, aramid fibers, carbon fibers, and boron fibers. Among these fibers, carbon fibers are suitably used because a fiber-reinforced composite material having a light weight, and at the same time, high strength and excellent mechanical properties such as high elastic modulus can be obtained.

“Dry reinforcing fiber” means a reinforcing fiber that is not impregnated with a matrix resin. Therefore, the preform for a fiber-reinforced composite material differs from a prepreg in which a reinforcing fiber is impregnated with a matrix resin. The dry reinforcing fiber, however, may be impregnated with a small amount of binder. “Binder” means a component that binds layers of stacked reinforcing fiber substrates together. In the fiber-reinforced composite material described below, the reinforcing fiber is impregnated with a resin composition so that the reinforcing fiber is not referred to as a dry reinforcing fiber.

The reinforcing fiber may be either of a staple fiber and a continuous fiber, or both the fibers can be used in combination. To obtain a fiber-reinforced composite material having a high fiber volume content (high Vf), a continuous fiber is preferably used.

The dry reinforcing fiber is sometimes used in a strand form, however, a dry reinforcing fiber substrate obtained by processing a reinforcing fiber into a form of mat, woven fabric, knit, braid, or unidirectional sheet is suitably used. Among these forms, woven fabrics are suitably used because a fiber-reinforced composite material having a high Vf is easily obtained and woven fabrics have a good handling property.

The fiber-reinforced composite material preferably has a fiber volume content Vf of 30 to 85%, and more preferably 35 to 70% with respect to the reinforcing fiber to have a high specific strength, or a high specific modulus. The fiber-reinforced composite material may have a fiber volume content Vf in the range from any lower limit to any upper limit described above. “Fiber volume content Vf of a fiber-reinforced composite material” means a value defined and measured in accordance with ASTM D3171 (1999) as follows. It thus means a value measured after the thermosetting resin composition is impregnated into the reinforcing fiber and cured. Therefore, the fiber volume content Vf of a fiber-reinforced composite material can be represented by Formula (4) described below using a thickness h of the fiber-reinforced composite material.

Fiber volume content Vf (%)=(Af×N)/(ρf×h)/10 (4)

Af: mass per one fiber substrate·1 m² (g/m²)
N: number of stacked fiber substrates
ρf: density of reinforcing fiber (g/cm³)
h: thickness of fiber-reinforced composite material (sample piece) (mm)
When the mass Af per one reinforcing fiber substrate·1 m², the number N of stacked fiber substrates, and the density ρf of the reinforcing fiber are not known, the fiber volume content of the fiber-reinforced composite material can be measured in accordance with JIS K 7075 (1991) by a combustion method, nitric acid decomposition method, or sulfuric acid decomposition method. Among these methods, the sulfuric acid decomposition method can be preferentially selected. As the density of the reinforcing fiber in this example, a value measured in accordance with JIS R 7603 (1999) is used.

A specific measurement method of the thickness h of the fiber-reinforced composite material should be a method that allows proper measurement of the thickness of the fiber-reinforced composite material, and is as accurate as, or more accurate than the micrometer specified in JIS B 7502 (1994) as described in JIS K 7072 (1991). When the fiber-reinforced composite material has too complex a shape to be measured, a sample (a sample having a shape and a size that are enough for the measurement) can be cut out from the fiber-reinforced composite material and measured.

The preform for a fiber-reinforced composite material contains the thermosetting resin composition and a dry reinforcing fiber substrate. The preform for a fiber-reinforced composite material has a form in which the thermosetting resin composition is in contact with the surface of the dry reinforcing fiber substrate directly or indirectly. For example, the preform may have a form in which the thermosetting resin composition is placed on the dry reinforcing fiber substrate, in which the dry reinforcing fiber substrate is placed on the thermosetting resin composition, or in which either of these forms are stacked. In addition, the preform may have a form in which the thermosetting resin composition and the dry reinforcing fiber substrate are in indirect contact with each other with a film or a nonwoven fabric interposed between the thermosetting resin composition and the dry reinforcing fiber substrate.

The fiber-reinforced composite material is a molded body containing a reinforcing fiber substrate and the thermosetting resin composition impregnated into the reinforcing fiber substrate, wherein the thermosetting resin composition is present as a cured product in the molded body. For example, the fiber-reinforced composite material is produced by impregnating the thermosetting resin composition into the dry reinforcing fiber substrate, molding the resulting product, and curing the composition.

The method of producing a fiber-reinforced composite material includes a molding step of melting the thermosetting resin composition, and molding the thermosetting resin composition while impregnating the thermosetting resin composition into a dry reinforcing fiber substrate, and a curing step of curing the thermosetting resin composition that is impregnated into the dry reinforcing fiber substrate and molded.

In the method of producing a fiber-reinforced composite material, various molding methods such as press molding methods, film bag molding methods, and autoclave molding methods can be used. Among these molding methods, the press molding methods are in particular suitably used from the viewpoint of the productivity and the shape flexibility of the molded body.

In the film bag molding methods, a preform including a thermosetting resin composition and a reinforcing fiber is placed between a rigid open mold and a flexible film, and the inside is sucked under vacuum. After that, the preform can be heated and molded while pressed with the atmospheric pressure, or with a gas or a liquid.

The method of producing a fiber-reinforced composite material will be described with reference to an example of the press molding methods. The fiber-reinforced composite material can be produced by, for example, placing the preform for a fiber-reinforced composite material containing the thermosetting resin composition and a dry reinforcing fiber in a mold heated to a predetermined temperature, and then pressing and heating the preform with a press. As a result, the resin composition is melted, impregnated into the reinforcing fiber substrate, and then cured as it is, and the fiber-reinforced composite material is produced.

From the viewpoint of the impregnating ability into a reinforcing fiber substrate, the temperature of the mold in the press molding is preferably equal to or higher than the temperature at which the complex viscosity η* of the used resin composition is lowered to 1×10¹ Pa·s.

### EXAMPLES

Hereinafter, our compositions, materials, preforms and methods will be described in more detail by way of examples.

### Resin Raw Materials

The following resin raw materials were used to obtain the thermosetting resin composition in each example. The unit of the content ratio in the resin compositions shown in Tables 1 to 3 is “part by mass” unless otherwise specified.

### 1. Base Resin

“jER” (registered trademark) YX4000 (manufactured by Mitsubishi Chemical Corporation): crystalline biphenyl epoxy resin, melting point=105° C.
“jER” (registered trademark) 1004AF (manufactured by Mitsubishi Chemical Corporation): glassy solid bisphenol A epoxy resin, no melting point

### 2. Curing Agent

“RIKACID” (registered trademark) TH (manufactured by New Japan Chemical Co., Ltd.): 1,2,3,6-tetrahydrophthalic anhydride, melting point=101° C.
Phthalic anhydride (manufactured by KANTO CHEMICAL CO., INC.): melting point=131° C. TS-G (manufactured by SHIKOKU CHEMICALS CORPORATION): glycoluril skeleton thiol compound, melting point=78° C.

### 3. Catalyst

TPP (manufactured by K.I Chemical Industry Co., Ltd.): triphenylphosphine, melting point=80° C.
2-Methylimidazole (manufactured by KANTO CHEMICAL CO., INC.): melting point=142° C.

### Preparation of Thermosetting Resin Composition

Each of the resin raw materials shown in Tables 1 to 3 was pulverized with a hammer mill, and then sifted using a screen having a pore size of 1 mm to obtain a powder raw material. Moreover, each of the resin raw materials was pulverized with a jet mill to obtain a powder raw material having a smaller particle size of 10 μm or less. After that, the obtained powder raw materials were sufficiently mixed at the compounding ratio shown in Tables 1 to 3, the mixture was put in a mold having a cavity longest diameter of 1.5 mm, 10 mm, or 100 mm up to 70% of the cavity volume, and pressed at the pressure shown in each of the examples and comparative examples to obtain a thermosetting resin composition.

### Melting Point Measurement of Crystalline Component

The melting point of the used resin raw materials were measured by differential scanning calorimetry (DSC) in accordance with JIS K 7121:2012. As a measuring device, Pyrisl DSC (manufactured by PerkinElmer Inc.) was used. The crystalline component was put in an aluminum crucible, and the measurement was performed in a nitrogen atmosphere at a temperature rising rate of 10° C./min. A DSC curve was obtained, and the temperature at the endothermic peak due to the melting of the component was measured to obtain the melting point.

### Longest Diameter Measurement of Thermosetting Resin Composition

The longest diameter of the thermosetting resin composition prepared as described above was measured with a caliper. The average of the five measured values was determined as the longest diameter of the sample.

### Specific Gravity Measurement of Thermosetting Resin Composition

The weight of the thermosetting resin composition prepared as described above was measured in the air and water at normal temperature, and the specific gravity was calculated by the Archimedes method. The amount of the measured sample was determined regardless of the size of the sample so that the sample had a weight of about 3 g in the air. The average of the five measured values was determined as the specific gravity of the sample.

### Porosity of Thermosetting Resin Composition

The specific gravity of each component contained in the thermosetting resin composition prepared as described above was calculated by the Archimedes method. The resulting specific gravities of the components were summed up according to the volume fraction at the compounding ratio of components contained in the thermosetting resin composition so that the specific gravity of the thermosetting resin composition having substantially no pore was calculated. The porosity of the thermosetting resin composition was calculated from the obtained specific gravity using the above-mentioned Formula (3).

### Domain Diameter Measurement of Thermosetting Resin Composition

The thermosetting resin composition prepared as described above was used as a sample, and the two-dimensional chemical composition mapping was obtained from the infrared absorption peak intensity specific to each component by the infrared spectroscopy (attenuated total reflection method) of the sample surface. In the obtained two-dimensional chemical composition mapping, the range in which the infrared absorption peak intensity of each component was continuously ⅓ or more of the maximum value was regarded as the domain of the component, and the width of the domain was measured on an arbitrary line drawn in the map along the X-axis. The domain widths were measured at 100 positions, and the average of the domain widths was employed as the domain diameter.

### Viscosity Measurement of Thermosetting Resin Composition

The thermosetting resin composition prepared as described above was used as a sample, and the viscosity was measured by dynamic viscoelasticity measurement. As a measuring device, ARES-G2 (manufactured by TA Instruments) was used. The sample was set on a 8 mm parallel plate, a pulling cycle of 0.5 Hz was applied to the sample, and the complex viscosity η* at 25° C. was measured.

### Measurement of Curing Time x at 150° C. of Thermosetting Resin Composition

To confirm the high-speed curability of the thermosetting resin composition prepared as described above, the curing time when the thermosetting resin composition was heated at 150° C. was determined by dielectric measurement. As the dielectric measuring device, MDE-10 Cure Monitor (manufactured by Holometrix Micromet) was used. A Viton O-ring having an inner diameter of 32 mm and a thickness of 3 mm was installed on the lower surface of a programmable mini-press MP2000 having a TMS-1 inch sensor embedded in the lower surface thereof, the temperature of the press was set at 150° C., the resin composition was set inside of the O-ring, the press was closed, and the temporal change of the ion viscosity of the resin composition was tracked. The dielectric measurement was performed at frequencies of 1 Hz, 10 Hz, 100 Hz, 1000 Hz, and 10000 Hz, and the logarithm Log(α) of the frequency-independent ion viscosity was obtained using the attached software.

After that, the cure index was determined by Formula (5), and the time when the cure index reached 90% was calculated to obtain the curing time x (min) at 150° C.

Cure index={log(αt)−log(α min)}/{log(α max)−log(α min)}×100 (5)

Cure index: (unit: %)
αt: ion viscosity at time t (unit: Ω·cm)
α min: minimum value of ion viscosity (unit: Ω·cm)
α max: maximum value of ion viscosity (unit: Ω·cm)
Measurement of Reaction Progress Rate y after One Week Storage at 40° C. of Thermosetting Resin Composition

To confirm the storage stability of the thermosetting resin composition prepared as described above, the curing reaction progress rate after one week storage under an environment at 40° C. was measured. For the measurement, differential scanning calorimetry (DSC) was used. The calorific value (E₁) due to the curing reaction of the resin composition immediately after the preparation and the calorific value (E₂) due to the curing reaction of the resin composition after one week storage in a hot air oven set at 40° C. were measured. The reaction progress rate y (%) after one week storage at 40° C. was calculated by Formula (6) described below:

Reaction progress rate y=(E₁−E₂)/E₁×100 (6)

### Handling Property at Room Temperature of Thermosetting Resin Composition

The handling property at room temperature of the thermosetting resin composition prepared as described above was comparatively evaluated on the following three scales. The thermosetting resin composition was lifted with a hand and evaluated as: “A” when caused no breaking or deformation, “B” when caused a partial crack or slight deformation, and “C” when easily caused breaking or deformation.

### Production of Fiber-Reinforced Composite Material

A fiber-reinforced composite material was produced by the following press molding method. In a mold that had a plate-shaped cavity having a size of 350 mm×700 mm×2 mm and was maintained at a predetermined temperature (molding temperature), about 290 g of the thermosetting resin composition prepared as described above was set on a substrate including 9 stacked sheets of carbon fiber fabric CO6343 (carbon fiber: T300-3K, weave: plain weave, fabric weight: 198 g/m², manufactured by Toray Industries, Inc.) as a reinforcing fiber. After that, mold clamping was performed with a press device. At that time, the inside pressure of the mold was reduced to the atmospheric pressure −0.1 MPa with a vacuum pump, and then, pressing was performed at a maximum pressure of 4 MPa. The mold temperature was set at a temperature 10° C. higher than the melting point of the component that had the highest melting point among the melting points of crystalline components contained in the used thermosetting resin composition. The mold was opened and the product inside was released 30 minutes after the start of the pressing to obtain a fiber-reinforced composite material.

Impregnating Ability into Reinforcing Fiber

The impregnating ability of the resin into the reinforcing fiber in the production of the fiber-reinforced composite material was comparatively evaluated on the following three scales based on the void amount in the fiber-reinforced composite material.

The impregnating ability was evaluated as: “A” when the void amount in the fiber-reinforced composite material was less than 1% and substantially no void existed, “B” when the void amount in the fiber-reinforced composite material was 1% or more and less than 3% and the fiber-reinforced composite material appeared to have no part unimpregnated with the resin, although the fiber-reinforced composite material appeared to have no part unimpregnated with the resin, and “C” when the void amount in the fiber-reinforced composite material was 3% or more and the fiber-reinforced composite material appeared to have a part unimpregnated with the resin.

To obtain the void amount in the fiber-reinforced composite material, a cross section arbitrarily selected in a smoothly polished fiber-reinforced composite material was smoothly polished, the polished surface was observed with a reflected light optical microscope, and the void amount was calculated from the void area rate in the fiber-reinforced composite material.

### Composition Unevenness of Fiber-Reinforced Composite Material

The composition unevenness of the fiber-reinforced composite material obtained as described above was comparatively evaluated on the following three scales.

The glass transition temperature (Tg) of the fiber-reinforced composite material was measured by differential scanning calorimetry (DSC) in accordance with JIS K 7121:2012 using 17 or more of samples that were uniformly cut out from the obtained fiber-reinforced composite material, and the composition unevenness was evaluated as: “A” when the difference between the maximum value and the minimum value in the result was less than 15° C., “B” when the difference was 15° C. or more and less than 30° C., and “C” when the difference was 30° C. or more.

### Example 1

As shown in Table 1, the powder raw materials of 100 parts by mass of crystalline biphenyl epoxy resin “‘jER’ (registered trademark) YX4000”, 83 parts by mass of 1,2,3,6-tetrahydrophthalic anhydride “‘RIKACID’ (registered trademark) TH”, and 5 parts by mass of triphenylphosphine “TPP” were sufficiently mixed, and an adequate amount of the mixture was put in a circular mold having a diameter of 100 mm, and then pressed at a pressure of 5 MPa to prepare a plate-shaped thermosetting resin composition. The thermosetting resin composition had a complex viscosity η* of 2.3×10⁸ Pa·s at 25° C. and a sufficient handling property although the thermosetting resin composition caused a partial crack when lifted with a hand. Moreover, the thermosetting resin composition contained a component having a domain diameter of 87 μm. The thermosetting resin composition was good in a balance between high-speed curability and storage stability.

A fiber-reinforced composite material that was produced using 5 plates of the resin composition (290 g in total) produced as described above and a dry reinforcing fiber substrate had some internal voids but no unimpregnated part on the surface. Therefore, the thermosetting resin composition showed a sufficient impregnating ability. From the fiber-reinforced composite material, 17 samples were uniformly cut out, and Tg was measured. The result showed that a uniform fiber-reinforced composite material having almost no unevenness depending on the position was obtained.

### Examples 2 to 4

Examples 2 to 4 were performed in the same manner as in Example 1 except that the mixture was pressed at a pressure of 10 MPa, 30 MPa, or 50 MPa, respectively, in the preparation of the thermosetting resin composition. All the thermosetting resin compositions had a complex viscosity η* of 2.3×10⁸ Pa·s at 25° C. and a good handling property so that the thermosetting resin compositions caused no crack when lifted with a hand. Moreover, the thermosetting resin compositions were good in a balance between high-speed curability and storage stability. A fiber-reinforced composite material that was produced using each of the thermosetting resin compositions and a dry reinforcing fiber substrate was a uniform fiber-reinforced composite material having almost no internal void and almost no unevenness. The result that the above-mentioned fiber-reinforced composite materials were obtained showed that the thermosetting resin compositions had a good impregnating ability.

### Example 5

Example 5 was performed in the same manner as in Example 3 except that a mold having a diameter of 1.5 mm was used and the thermosetting resin composition was granular. The thermosetting resin composition had a complex viscosity η* of 2.3×10⁸ Pa·s at 25° C. and a good handling property so that the thermosetting resin composition caused no crack when lifted with a hand. Moreover, the thermosetting resin compositions were good in a balance between high-speed curability and storage stability. A fiber-reinforced composite material that was produced using 290 g of the thermosetting resin composition and a dry reinforcing fiber substrate had some internal voids, however, was a uniform fiber-reinforced composite material having no unimpregnated part on the surface and almost no unevenness. The result that the above-mentioned fiber-reinforced composite material was obtained showed that the thermosetting resin composition had a sufficient impregnating ability.

### Example 6

Example 6 was performed in the same manner as in Example 3 except that a mold having a diameter of 10 mm was used and the thermosetting resin composition was clumpy. The thermosetting resin composition had a complex viscosity η* of 2.3×10⁸ Pa·s at 25° C. and a good handling property so that the thermosetting resin composition caused no crack when lifted with a hand. Moreover, the thermosetting resin compositions were good in a balance between high-speed curability and storage stability. A fiber-reinforced composite material that was produced using 290 g of the thermosetting resin composition and a dry reinforcing fiber substrate was a uniform fiber-reinforced composite material having almost no internal void, a good impregnating ability, and almost no unevenness. The result that the above-mentioned fiber-reinforced composite material was obtained showed that the thermosetting resin composition had a sufficient impregnating ability.

### Example 7

Example 7 was performed in the same manner as in Example 2 except that 0.5 parts by mass of 2-methylimidazole was used as a catalyst as shown in Table 2. The thermosetting resin composition had a complex viscosity η* of 2.2×10⁸ Pa·s at 25° C. and a good handling property so that the thermosetting resin composition caused no crack when lifted with a hand. Moreover, the thermosetting resin composition had a high-speed curability a little lowered, however, was sufficient in a balance between high-speed curability and storage stability. A fiber-reinforced composite material that was produced using each of the thermosetting resin compositions and a dry reinforcing fiber substrate was a uniform fiber-reinforced composite material having almost no internal void and almost no unevenness. The result that the above-mentioned fiber-reinforced composite materials were obtained showed that the thermosetting resin compositions had a good impregnating ability.

### Examples 8 and 9

Examples 8 and 9 were performed in the same manner as in Example 7 except that 1 part by mass of 2-methylimidazole and 15 parts by mass of 2-methylimidazole were blended as a catalyst, respectively. The thermosetting resin compositions had a complex viscosity η* of 2.2×10⁸ Pa·s at 25° C. and a good handling property so that the thermosetting resin compositions caused no crack when lifted with a hand. Moreover, the thermosetting resin compositions were sufficient in a balance between high-speed curability and storage stability. A fiber-reinforced composite material that was produced using each of the thermosetting resin compositions and a dry reinforcing fiber substrate was a uniform fiber-reinforced composite material having almost no internal void and almost no unevenness. The result that the above-mentioned fiber-reinforced composite materials were obtained showed that the thermosetting resin compositions had a good impregnating ability.

### Example 10

Example 10 was performed in the same manner as in Example 7 except that 30 parts by mass of 2-methylimidazole was blended as a catalyst. The thermosetting resin composition had a complex viscosity η* of 2.2×10⁸ Pa·s at 25° C. and a good handling property so that the thermosetting resin composition caused no crack when lifted with a hand. Moreover, the thermosetting resin compositions were sufficient in a balance between high-speed curability and storage stability. A fiber-reinforced composite material that was produced using the thermosetting resin composition and a dry reinforcing fiber substrate had some internal voids, however, was a uniform fiber-reinforced composite material having almost no unevenness. The result that the above-mentioned fiber-reinforced composite material was obtained showed that the thermosetting resin composition had a sufficient impregnating ability.

### Example 11

Example 11 was performed in the same manner as in Example 3 except that as shown in Table 2, the powder raw materials of 50 parts by mass of crystalline biphenyl epoxy resin “‘jER’ (registered trademark) YX4000”, 50 parts by mass of glassy solid bisphenol A epoxy resin “‘jER’ (registered trademark) 1004AF”, 49 parts by mass of 1,2,3,6-tetrahydrophthalic anhydride “‘RIKACID’ (registered trademark) TH), and 5 parts by mass of triphenylphosphine “TPP” were sufficiently mixed. The thermosetting resin composition had a complex viscosity η* of 1.7×10⁸ Pa·s at 25° C. and a sufficient handling property so that the thermosetting resin composition caused no crack when lifted with a hand. Moreover, the thermosetting resin compositions were good in a balance between high-speed curability and storage stability. A fiber-reinforced composite material that was produced using the thermosetting resin composition and a dry reinforcing fiber substrate had some internal voids but no unimpregnated part on the surface. The result that the above-mentioned fiber-reinforced composite material was obtained showed that the thermosetting resin composition had a sufficient impregnating ability.

### Example 12

Example 12 was performed in the same manner as in Example 2 except that 80 parts by mass of phthalic anhydride was used as a curing agent. The thermosetting resin composition had a complex viscosity η* of 1.5×10⁸ Pa·s at 25° C. and a good handling property so that the thermosetting resin composition caused no crack when lifted with a hand. Moreover, the thermosetting resin compositions were sufficient in a balance between high-speed curability and storage stability. A fiber-reinforced composite material that was produced using the thermosetting resin composition and a dry reinforcing fiber substrate was a uniform fiber-reinforced composite material having almost no unevenness. The result that the above-mentioned fiber-reinforced composite materials were obtained showed that the thermosetting resin compositions had a good impregnating ability.

### Example 13

Example 13 was performed in the same manner as in Example 3 except that 51 parts by mass of a glycoluril skeleton thiol compound was used as a curing agent and no catalyst was used. The thermosetting resin composition had a complex viscosity η* of 1.0×10⁸ Pa·s at 25° C. and a good handling property so that the thermosetting resin composition caused no crack when lifted with a hand. Moreover, the thermosetting resin compositions were sufficient in a balance between high-speed curability and storage stability. A fiber-reinforced composite material that was produced using the thermosetting resin composition and a dry reinforcing fiber substrate had some internal voids, however, was sufficiently uniform.

### Examples 14 to 17

Examples 14 to 17 were performed in the same manner as in Example 3 except that the size of each powder raw material was changed so that the domain diameter was 1 μm, 15 μm, 284 μm, or 492 μm as shown in Table 3. All the thermosetting resin compositions had a complex viscosity η* of 2.3×10⁸ Pa·s at 25° C. and a good handling property so that the thermosetting resin compositions caused no crack when lifted with a hand. Moreover, the thermosetting resin compositions were good in a balance between high-speed curability and storage stability. A fiber-reinforced composite material that was produced using each of the thermosetting resin compositions and a dry reinforcing fiber substrate was a uniform fiber-reinforced composite material having almost no internal void and almost no unevenness. The result that the above-mentioned fiber-reinforced composite materials were obtained showed that the thermosetting resin compositions had a good impregnating ability.

### Comparative Example 1

Comparative Example 1 was performed in the same manner as in Example 1 except that the mixture was pressed under a pressure of 1 MPa in the preparation of the thermosetting resin composition. The thermosetting resin composition had a complex viscosity η* of 2.3×10⁸ Pa·s at 25° C., however, was deficient in a handling property so that the thermosetting resin composition easily caused a crack when lifted with a hand. A fiber-reinforced composite material that was produced using the thermosetting resin composition and a dry reinforcing fiber substrate had many internal voids.

### Comparative Example 2

Comparative Example 2 was performed in the same manner as in Example 1 except that the mixture of components was heated to a temperature equal to or higher than the melting point of each component, and melted and stirred so that the components were compatibilized, and an adequate amount of the resulting product was put in a mold having a longest diameter of 100 mm, and cooled to prepare a thermosetting resin composition. The thermosetting resin composition had a complex viscosity η* of 2.5×10⁸ Pa·s at 25° C. and a good handling property, however, was deficient in a storage stability because the components were compatibilized with each other.

TABLE 1

| | | | Example | Example | Example | Example | Example | Example |
|---|---|---|---|---|---|---|---|---|
| | | | 1 | 2 | 3 | 4 | 5 | 6 |
| Base resin | Crystalline biphenyl epoxy resin | YX4000 | 100 | 100 | 100 | 100 | 100 | 100 |
| | Glassy solid bisphenol A epoxy resin | jER1004AF | | | | | | |
| Curing agent | 1,2,3,6-Tetrahydrophthalic anhydride | TH | 83 | 83 | 83 | 83 | 83 | 83 |
| | Phthalic anhydride | | | | | | | |
| | Glycoluril skeleton thiol compound | TS-G | | | | | | |
| Catalyst | Triphenylphosphine | TPP | 5 | 5 | 5 | 5 | 5 | 5 |

| | | | | | | | |
|---|---|---|---|---|---|---|---|
| | 2-Methylimidazole | | | | | | |
| Resin | Longest diameter [mm] | 100 | 100 | 100 | 100 | 1.5 | 10 |
| properties | Specific gravity [g/cm³] | 0.93 | 0.97 | 1.02 | 1.10 | 1.02 | 1.02 |
| | Porosity [%] | 23 | 20 | 16 | 9 | 16 | 16 |
| | Domain diameter [μm] | 87 | 85 | 85 | 80 | 85 | 85 |
| | Curing time (x) at 150° C. [min] | 2.9 | 2.9 | 2.9 | 2.9 | 2.9 | 2.9 |
| | Reaction progress rate (y) after one | 1.6 | 1.8 | 2.4 | 2.8 | 1.6 | 1.6 |
| | week storage at 40° C. [%] | | | | | | |
| | x × y | 4.6 | 5.2 | 7.0 | 8.1 | 4.6 | 4.6 |
| | Handling property | B | A | A | A | A | A |
| Properties of | Impregnating ability | B | A | A | A | B | A |
| composite | Composition unevenness | A | A | A | A | A | A |
| material | | | | | | | |

TABLE 2

| | | | Example | Example | Example | Example | Example | Example | Example |
|---|---|---|---|---|---|---|---|---|---|
| | | | 7 | 8 | 9 | 10 | 11 | 12 | 13 |
| Base resin | Crystalline biphenyl epoxy resin | YX4000 | 100 | 100 | 100 | 100 | 50 | 100 | 100 |
| | Glassy solid bisphenol A epoxy resin | jER1004AF | | | | | 50 | | |
| Curing agent | 1,2,3,6-Tetrahydrophthalic anhydride | TH | 83 | 83 | 83 | 83 | 49 | | |
| | Phthalic anhydride | | | | | | | 80 | |
| | Glycoluril skeleton thiol compound | TS-G | | | | | | | 51 |
| Catalyst | Triphenylphosphine | TPP | | | | | 5 | 5 | |

| | | | | | | | | |
|---|---|---|---|---|---|---|---|---|
| | 2-Methylimidazole | 0.5 | 1 | 15 | 30 | | | |
| Resin | Longest diameter [mm] | 100 | 100 | 100 | 100 | 100 | 100 | 100 |
| properties | Specific gravity [g/cm³] | 1.03 | 1.03 | 1.03 | 1.03 | 1.02 | 1.03 | 1.02 |
| | Porosity [%] | 15 | 15 | 15 | 15 | 16 | 15 | 16 |
| | Domain diameter [μm] | 85 | 85 | 88 | 90 | 90 | 88 | 80 |
| | Curing time (x) at 150° C. [min] | 5.9 | 4.1 | 2.3 | 1.5 | 4.5 | 3 | 0.4 |
| | Reaction progress rate (y) after one week | 2.8 | 3.2 | 5.4 | 7.9 | 1.8 | 1.8 | 30 |
| | storage at 40° C. [%] | | | | | | | |
| | x × y | 16.5 | 13.1 | 12.4 | 11.9 | 8.1 | 5.4 | 12.0 |
| | Handling property | A | A | A | A | A | A | A |
| Properties of | Impregnating ability | A | A | A | A | B | A | B |
| composite | Composition unevenness | B | A | A | B | A | A | B |
| material | | | | | | | | |

TABLE 3

| | | | Example | Example | Example | Example | Comparative | Comparative |
|---|---|---|---|---|---|---|---|---|
| | | | 14 | 15 | 16 | 17 | Example 1 | Example 2 |
| Base resin | Crystalline biphenyl epoxy resin | YX4000 | 100 | 100 | 100 | 100 | 100 | 100 |
| | Glassy solid bisphenol A epoxy resin | jER1004AF | | | | | | |
| Curing agent | 1,2,3,6-Tetrahydrophthalic anhydride | TH | 83 | 83 | 83 | 83 | 83 | 83 |
| | Phthalic anhydride | | | | | | | |
| | Glycoluril skeleton thiol compound | TS-G | | | | | | |
| Catalyst | Triphenylphosphine | TPP | 5 | 5 | 5 | 5 | 5 | 5 |

| | | | | | | | |
|---|---|---|---|---|---|---|---|
| | 2-Methylimidazole | | | | | | |
| Resin | Longest diameter [mm] | 100 | 100 | 100 | 100 | 100 | 100 |
| properties | Specific gravity [g/cm³] | 1.03 | 1.02 | 1.02 | 1.01 | 0.84 | 1.02 |
| | Porosity [%] | 15 | 16 | 16 | 17 | 31 | 16 |
| | Domain diameter [μm] | 1 | 15 | 284 | 492 | 87 | — |
| | Curing time (x) at 150° C. [min] | 2.7 | 2.8 | 3.2 | 3.3 | 2.9 | 2.9 |
| | Reaction progress rate (y) after one week | 2.3 | 2.1 | 1.3 | 0.6 | 1.5 | 53 |
| | storage at 40° C. [%] | | | | | | |
| | x × y | 6.2 | 5.9 | 4.2 | 2.0 | 4.4 | 153.7 |
| | Handling property | A | A | A | A | C | B |
| Properties of | Impregnating ability | A | A | A | A | C | A |
| composite | Composition unevenness | A | A | A | A | A | A |
| material | | | | | | | |

### INDUSTRIAL APPLICABILITY

The thermosetting resin composition is good in a balance between high-speed curability and storage stability, and the impregnating ability into a reinforcing fiber substrate. Therefore, an adjusted resin can be stored for a long time, and a fiber-reinforced composite material can be provided more conveniently by a press molding method and the like with high productivity. As a result, the fiber-reinforced composite material is increasingly employed especially for cars and aircraft, and it can be expected that the more weight saving of cars and aircraft leads to the fuel consumption improvement and contribution to reduction of global warming gas emission.

1.-8. (canceled)

9. A thermosetting resin composition for a fiber-reinforced composite material comprising:
a domain of a base resin [A]; and
a domain of a curing agent [B] and/or a domain of a catalyst [C],
the thermosetting resin composition having a specific gravity of 0.90 to 1.30, and a complex viscosity η* determined by dynamic viscoelasticity measurement at 25° C. of 1×10⁷ Pa·s or more.

10. A thermosetting resin composition for a fiber-reinforced composite material comprising:
a domain of a base resin [A]; and
a domain of a curing agent [B] and/or a domain of a catalyst [C],
the thermosetting resin composition having a porosity of 0.1 to 25%, and a complex viscosity η* determined by dynamic viscoelasticity measurement at 25° C. of 1×10⁷ Pa·s or more.

11. The thermosetting resin composition for a fiber-reinforced composite material according to claim 9, having a longest diameter of 1.5 mm or more.

12. The thermosetting resin composition for a fiber-reinforced composite material according to claim 9, wherein a product of a curing time x (min) at 150° C. and a curing reaction progress rate y (%) after one week storage under an environment at 40° C. satisfies Formula (1):
0≤x×y≤40 (1)
wherein x is 0.1≤x≤300, and y is 0≤y≤50.

13. The thermosetting resin composition for a fiber-reinforced composite-material according to claim 9, comprising the catalyst [C], and having a content of the catalyst [C] of 1 to 30% by mass based on 100% by mass of the thermosetting resin composition.

14. A preform for a fiber-reinforced composite material comprising:
the thermosetting resin composition according to claim 9; and
a dry reinforcing fiber substrate.

15. A fiber-reinforced composite material that is a molded body comprising a reinforcing fiber substrate and the thermosetting resin composition according to claim 9 impregnated into the reinforcing fiber substrate, wherein the thermosetting resin composition is present as a cured product in the molded body.

16. A method of producing a fiber-reinforced composite material comprising:
a molding step of melting the thermosetting resin composition according to claim 9, and molding the thermosetting resin composition while impregnating the thermosetting resin composition into a dry reinforcing fiber substrate; and
a curing step of curing the thermosetting resin composition that is impregnated into the dry reinforcing fiber substrate and molded.

17. The thermosetting resin composition for a fiber-reinforced composite material according to claim 10, having a longest diameter of 1.5 mm or more.

18. The thermosetting resin composition for a fiber-reinforced composite material according to claim 10, wherein a product of a curing time x (min) at 150° C. and a curing reaction progress rate y (%) after one week storage under an environment at 40° C. satisfies Formula (1):
0≤x×y≤40 (1)
wherein x is 0.1≤x≤300, and y is 0≤y≤50.

19. The thermosetting resin composition for a fiber-reinforced composite material according to claim 11, wherein a product of a curing time x (min) at 150° C. and a curing reaction progress rate y (%) after one week storage under an environment at 40° C. satisfies Formula (1):
0≤x×y≤40 (1)
wherein x is 0.1≤x≤300, and y is 0≤y≤50.

20. The thermosetting resin composition for a fiber-reinforced composite material according to claim 10, comprising the catalyst [C], and having a content of the catalyst [C] of 1 to 30% by mass based on 100% by mass of the thermosetting resin composition.

21. The thermosetting resin composition for a fiber-reinforced composite material according to claim 11, comprising the catalyst [C], and having a content of the catalyst [C] of 1 to 30% by mass based on 100% by mass of the thermosetting resin composition.

22. The thermosetting resin composition for a fiber-reinforced composite material according to claim 12, comprising the catalyst [C], and having a content of the catalyst [C] of 1 to 30% by mass based on 100% by mass of the thermosetting resin composition.

23. A preform for a fiber-reinforced composite material comprising:
the thermosetting resin composition according to claim 10; and
a dry reinforcing fiber substrate.

24. A preform for a fiber-reinforced composite material comprising:
the thermosetting resin composition according to claim 11; and
a dry reinforcing fiber substrate.

25. A preform for a fiber-reinforced composite material comprising:
the thermosetting resin composition according to claim 12; and
a dry reinforcing fiber substrate.

26. A preform for a fiber-reinforced composite material comprising:
the thermosetting resin composition according to claim 13; and
a dry reinforcing fiber substrate.

27. A fiber-reinforced composite material that is a molded body comprising a reinforcing fiber substrate and the thermosetting resin composition according to claim 10 impregnated into the reinforcing fiber substrate, wherein the thermosetting resin composition is present as a cured product in the molded body.

28. A fiber-reinforced composite material that is a molded body comprising a reinforcing fiber substrate and the thermosetting resin composition according to claim 11 impregnated into the reinforcing fiber substrate, wherein the thermosetting resin composition is present as a cured product in the molded body.
